(19) United States
(12) Patent Application Publication
(10) Pub. No.: US 2026/0201831 A1
(43) Pub. Date: Jul. 16, 2026

(54) Rotary Engine Housing

(71) Applicant: Pratt & Whitney Canada Corp., Longueuil, Quebec (CA)

(72) Inventors: Jean-Philippe SIMONEAU, Saint-Constant (CA); David GAGNON-MARTIN, Longueuil (CA); Sebastien BOLDUC, Saint-Bruno-de-Montarville (CA)

(21) Appl. No.: 19/017,038

(22) Filed: Jan. 10, 2025

(51) Int. Cl. F02B 55/10; F01C 1/22; F01C 19/08; F01C 19/10; F01C 21/06; F01C 21/10; F02B 53/00

(52) U.S. Cl. CPC F02B 55/10; F01C 1/22; F01C 19/08; F01C 19/10; F01C 21/06; F01C 21/108; F02B 2053/005; F04C 2230/602; F04C 2240/80

(57) ABSTRACT

An engine housing includes a rotor housing and a side housing assembly. The side housing assembly includes a side housing body, a side plate, and a shim assembly. The side plate is disposed between the rotor housing body and the side housing body. The side plate includes an inner plate side, an outer plate side, and a perimeter edge. The inner plate side further forms the rotor cavity. The shim assembly includes a shim body and at least one compliant member. The shim body extends between and to an outer side surface and an inner side surface. The outer side surface is disposed on the side housing body. The inner side surface is disposed adjacent and spaced from the outer plate side by a gap. The at least one compliant member is disposed between and contacting the shim body and the outer plate side at the inner side surface.

### TECHNICAL FIELD

This disclosure relates generally to aircraft powerplant assemblies and, more particularly, to engine housings.

### BACKGROUND OF THE ART

A rotary engine for an aircraft may be configured, for example, as a Wankel engine. The rotary engine includes one or more rotors configured to eccentrically rotate within an engine housing. The engine housing may include one or more housing components assembled together to form the engine housing. Various engine housing configurations re known in the art. While these known engine housing configurations may be suitable for their intended purposes, there is always room in the art for improvement.

### SUMMARY

According to an aspect of the present disclosure, an engine housing for a powerplant assembly includes a rotor housing and a side housing assembly. The rotor housing includes a rotor housing body. The rotor housing body extends about an axis to form a rotor cavity of the engine housing. The rotor housing body extends between and to a first axial housing end and a second axial housing end. The side housing assembly includes a side housing body, a side plate, and a shim assembly. The side housing body is disposed at the first axial housing end. The side plate is disposed axially between the rotor housing body and the side housing body. The side plate includes an inner plate side, an outer plate side, and a perimeter edge extending from the inner plate side to the outer plate side. The inner plate side further forms the rotor cavity. The shim assembly includes a shim body and at least one compliant member. The shim body extends between and to an outer axial side surface and an inner axial side surface. The outer axial side surface is disposed on the side housing body. The inner axial side surface is disposed adjacent and axially spaced from the outer plate side by an axial gap. The at least one compliant member is disposed between and contacting the shim body and the outer plate side at the inner axial side surface.

In any of the aspects or embodiments described above and herein, the side housing body and the side plate may form a coolant passage extending about the rotational axis, and the shim assembly may be disposed at the coolant passage.

In any of the aspects or embodiments described above and herein, the side housing body may form a sealing surface, an inner wall, and a shoulder, the sealing surface may contact the rotor housing radially outward of the coolant passage, the inner wall may be transverse to the sealing surface, the shoulder may project outward from the inner wall, and the outer axial side surface may be disposed on the shoulder.

In any of the aspects or embodiments described above and herein, the inner wall and the shoulder may be interrupted by a plurality of secondary channels of the coolant passage, and the outer axial side surface may form a portion of each of the plurality of secondary channels.

In any of the aspects or embodiments described above and herein, the engine housing may further include a fluid seal disposed between the inner plate side and the rotor housing body, and the shim assembly may be radially coincident with the fluid seal.

In any of the aspects or embodiments described above and herein, the side housing assembly may further include an inner shim disposed radially inward of the shim assembly, the inner shim may be disposed on the side housing body, and the inner shim may be configured to contact the side plate on the outer plate side.

In any of the aspects or embodiments described above and herein, the side housing assembly may include a shim structure including the shim body, the inner shim, and a plurality of bridge segments extending between and connecting the shim body and the inner shim.

In any of the aspects or embodiments described above and herein, the shim body may include a rigid shim material and the at least one compliant member may include an elastomeric seal material.

In any of the aspects or embodiments described above and herein, the shim body may form a seal groove on the inner axial side surface and the at least one compliant member may be disposed within the seal groove.

In any of the aspects or embodiments described above and herein, the at least one compliant member may include a first compliant member and a second compliant member axially spaced from the first compliant member.

In any of the aspects or embodiments described above and herein, the shim assembly may be disposed at the perimeter edge.

According to another aspect of the present disclosure, an engine housing for a powerplant assembly includes a rotor housing and a side housing assembly. The rotor housing includes a rotor housing body. The rotor housing body extends about an axis to form a rotor cavity of the engine housing. The rotor housing body extends between and to a first axial housing end and a second axial housing end. The side housing assembly includes a side housing body, a side plate, and a shim assembly. The side housing body is disposed at the first axial housing end. The side plate includes an inner plate side, an outer plate side, and a perimeter edge extending from the inner plate side to the outer plate side. The perimeter edge is disposed axially between the rotor housing body and the side housing body. The inner plate side further forms the rotor cavity. The shim assembly is disposed at the perimeter edge. The shim assembly includes a shim body and at least one compliant member. The shim body is disposed on the side housing body and axially spaced from the outer plate side by an axial gap. The at least one compliant member is disposed between the shim body and the outer plate side forming the axial gap.

In any of the aspects or embodiments described above and herein, the shim body and the at least one compliant member may extend about the axis between the side housing body and the side plate.

In any of the aspects or embodiments described above and herein, the side housing body and the side plate may form a coolant passage extending about the rotational axis, and the shim assembly may be disposed at the coolant passage.

In any of the aspects or embodiments described above and herein, the side housing body may form a sealing surface, an inner wall, and a shoulder, the sealing surface may contact the rotor housing radially outward of the coolant passage, the inner wall may be transverse to the sealing surface, the shoulder may project outward from the inner wall, and the shim body may be disposed on the shoulder.

In any of the aspects or embodiments described above and herein, the inner wall and the shoulder may be interrupted by a plurality of secondary channels of the coolant passage, and the shim body may form a portion of each of the plurality of secondary channels.

According to an aspect of the present disclosure, a powerplant assembly for an aircraft includes a driven rotor, an engine shaft, a rotor assembly, a rotor housing, and a side housing assembly. The engine shaft is operably coupled with the driven rotor. The engine shaft is rotatable about a rotational axis. The rotor assembly includes a first rotor coupled with the engine shaft. The rotor housing forms a rotor cavity for the first rotor. The rotor housing includes a rotor housing body. The rotor housing body extends about the rotational axis. The rotor housing body extends between and to a first axial housing end and a second axial housing end. The side housing assembly includes a side housing body, a side plate, and a shim assembly. The side housing body is disposed at the first axial housing end. The side plate is disposed axially between the rotor housing body and the side housing body. The side plate includes an inner plate side, an outer plate side, and a perimeter edge extending from the inner plate side to the outer plate side. The inner plate side further forms the rotor cavity. The shim assembly includes a shim body and at least one compliant member. The shim body extends between and to an outer axial side surface and an inner axial side surface. The shim body extends between and to an outer radial side surface and an inner radial side surface. The outer axial side surface, the outer radial side surface, and the inner radial side surface are disposed on the side housing body. The inner axial side surface is disposed adjacent and axially spaced from the outer plate side by an axial gap. The at least one compliant member is disposed between and contacting the shim body and the outer plate side at the inner axial side surface.

In any of the aspects or embodiments described above and herein, the shim body may form a seal groove on the inner axial side surface and the at least one compliant member may be disposed within the seal groove.

In any of the aspects or embodiments described above and herein, the at least one compliant member may include a first compliant member and a second compliant member axially spaced from the first compliant member.

In any of the aspects or embodiments described above and herein, the at least one compliant member may include a compliant metallic seal.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### DESCRIPTION OF THE DRAWINGS

FIG. 1 illustrates an aircraft including a propulsion system, in accordance with one or more embodiments of the present disclosure.

FIG. 2 schematically illustrates a cutaway, side view of a powerplant assembly for an aircraft, in accordance with one or more embodiments of the present disclosure.

FIG. 3 schematically illustrates a cutaway, side view of an engine housing of the powerplant assembly, in accordance with one or more embodiments of the present disclosure.

FIG. 4 illustrates a view of the engine housing taken along Line 4-4 of FIG. 3, in accordance with one or more embodiments of the present disclosure.

FIG. 5 illustrates a cutaway, side view of a portion of the engine housing, in accordance with one or more embodiments of the present disclosure.

FIG. 6 illustrates an inner side view of a side housing body of the engine housing, in accordance with one or more embodiments of the present disclosure.

FIG. 7 illustrates a cutaway, side view of a portion of the engine housing including an outer shim assembly, in accordance with one or more embodiments of the present disclosure.

FIG. 8 illustrates a cutaway, side view of a portion of another engine housing including a shim structure, in accordance with one or more embodiments of the present disclosure.

FIG. 9 illustrates a front view of a portion of the shim structure of FIG. 8, in accordance with one or more embodiments of the present disclosure.

### DETAILED DESCRIPTION

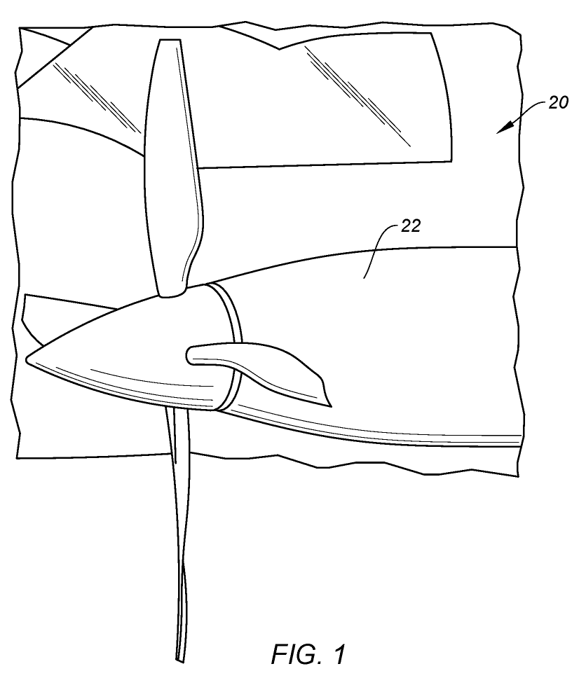

FIG. 1 illustrates an aircraft 20 including at least one propulsion system 22. The aircraft 20 of FIG. 1 is a fixed-wing aircraft (e.g., an airplane). However, the aircraft 20 may alternatively be a rotary-wing aircraft (e.g., a helicopter or other rotorcraft), a tilt-rotor aircraft, a tilt-wing aircraft, or another aerial vehicle. Moreover, the aircraft may be a manned aerial vehicle or an unmanned aerial vehicle (UAV, e.g., a drone).

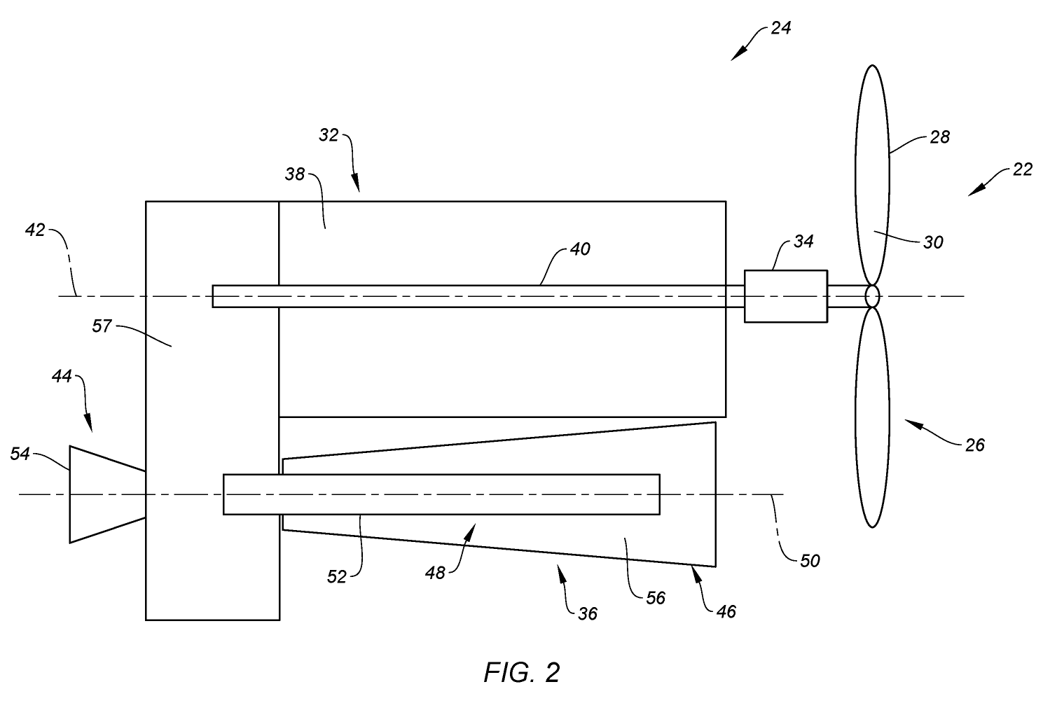

FIG. 2 schematically illustrates a powerplant assembly 24. As shown in FIG. 2, the powerplant assembly 24 may form a portion of the propulsion system 22. Alternatively, the powerplant assembly 24 may form a portion of an electric power system (or more generally an electric machine) such as, but not limited to, an auxiliary power unit (APU) for the aircraft 20. While the powerplant assembly 24 is described herein with respect to aircraft applications, aspects of the present disclosure powerplant assembly 24 may also be equally applicable to ground-based powerplant applications (e.g., ground-based power generation, ground-based vehicles, etc.). The propulsion system 22 of FIG. 2 includes the powerplant assembly 24 and a mechanical load 26. The mechanical load 26 may be configured as or otherwise include a rotor 28 mechanically driven by the powerplant assembly 24. This driven rotor 28 may be a bladed propulsor rotor 30 (e.g., an air mover) where the powerplant assembly 24 is (or is part of) the propulsion system 22, as shown in FIG. 2. The propulsor rotor 30 (e.g., a propeller, a rotorcraft rotor, etc.) includes a plurality of rotor blades arranged circumferentially around and connected to at least (or only) one rotor disk or hub. Alternatively, the driven rotor 28 may be a generator rotor in an electric power generator (or more generally an electric machine).

The powerplant assembly 24 includes an engine 32. The powerplant assembly 24 may additionally include a geartrain 34 and/or a turbocompressor 36. The engine 32 of FIG. 2 is configured as a rotary intermittent internal combustion engine. As will be described in further detail, the engine 32 may be configured, for example, as a Wankel engine in which an eccentric rotor configuration is used to convert fluid pressure into rotational motion. The engine 32 includes a rotor assembly 38 and an engine shaft 40. The rotor assembly 38 is coupled with the engine shaft 40 and configured to drive rotation of the engine shaft 40 about a rotational axis 42. The engine shaft 40 is coupled with the driven rotor 28 such that rotation of the engine shaft 40 by the rotor assembly 38 drives rotation of the driven rotor 28. For example, the engine shaft 40 may be coupled with the driven rotor 28 by the geartrain 34 (e.g., a transmission, a speed change device, an epicyclic geartrain, etc.).

The turbocompressor 36 of FIG. 2 includes a compressor section 44, a turbine section 46, and a rotational assembly 48 (e.g., a spool). The rotational assembly 48 is rotatable about a rotational axis 50. The rotational assembly 48 includes a shaft 52, a bladed compressor rotor 54 of the compressor section 44, and a bladed turbine rotor 56 of the turbine section 46. The shaft 52 interconnects the bladed compressor rotor 54 and the bladed turbine rotor 56. The rotational assembly 48 (e.g., the shaft 52) may be coupled with the engine shaft 40 by a geartrain 57, thereby allowing the engine 32 and/or the bladed turbine rotor 56 to rotationally drive the bladed compressor rotor 44. In operation, ambient air is received by the compressor section 44 and compressed by rotation of the bladed compressor rotor 54. This compressed air is directed to an air intake of the engine 32 to facilitate an internal combustion process of the engine 32. Combustion exhaust gas from the engine 32 is directed to the turbine section 46, thereby causing the bladed turbine rotor 56 to rotate and rotationally drive the rotational assembly 48.

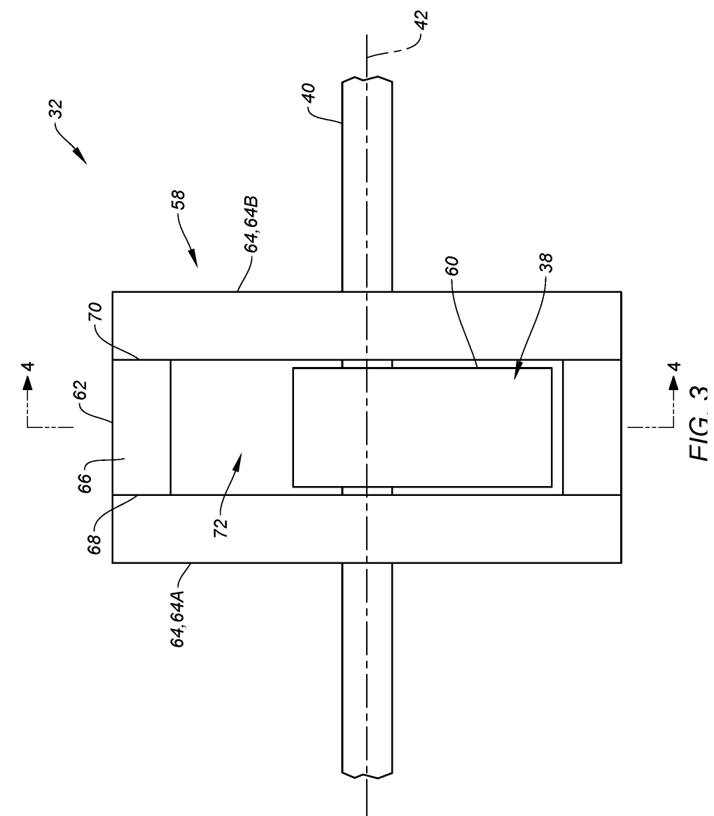

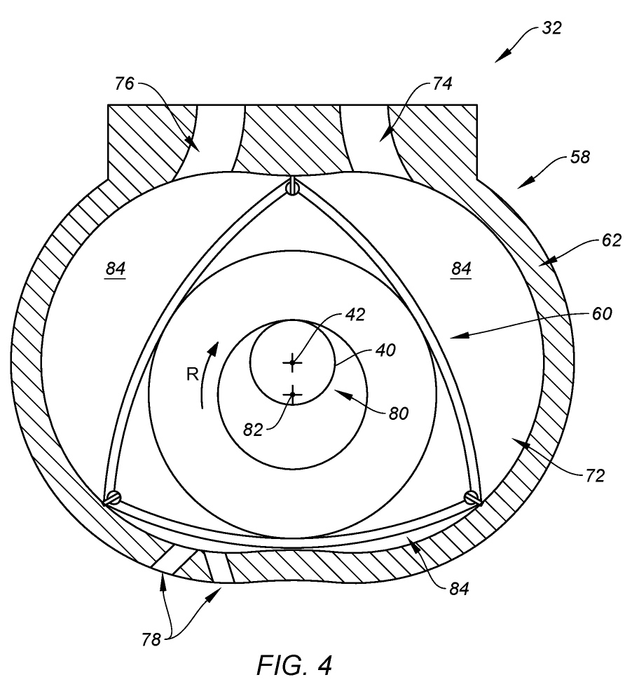

FIGS. 3 and 4 illustrate portions of the engine 32 in greater detail. FIGS. 3 and 4 illustrate an engine housing 58 of the engine 32. FIG. 3 illustrates a cutaway, side view of the engine housing 58. FIG. 4 illustrates a cross-sectional view of the engine housing 58 taken along Line 4-4 of FIG. 3. FIGS. 3 and 4 further illustrate a rotor 60 of the rotor assembly 38. FIGS. 3 and 4 illustrate the engine housing 58 for a single rotor (e.g., the rotor 60), however, the engine 32 may include a plurality of rotors axially distributed and separated (e.g., within discrete rotor cavities) from one another within the engine housing 58.

The engine housing 58 of FIGS. 3 and 4 includes a rotor housing 62 and opposing side housing assemblies 64. The rotor housing 62 includes a rotor housing body 66 extending (e.g., axially extending) between and to a first end 68 of the rotor housing body 66 and a second end 70 of the rotor housing body 66. The rotor housing body 66 may extend about (e.g., completely around) the rotational axis 42. The rotor housing body 66 includes a rotor housing body material. The rotor housing body material may form all or a substantial portion of the rotor housing body 66. The rotor housing body material may be metal such as, but not limited to aluminum. The present disclosure, however, is not limited to the use of a particular material or combination of materials for the rotor housing body material.

The rotor housing body 66 of FIGS. 2 and 3 surrounds and forms a rotor cavity 72. The rotor cavity 72 of FIGS. 3 and 4 is formed with two lobes, which two lobes may collectively be configured with an epitrochoid shape. The rotor housing body 66 further forms an intake port 74, an exhaust port 76, and one or more fuel system passages 78. The intake port 74 is in fluid communication with the rotor cavity 72. The intake port 74 is configured to direct compressed air to the rotor cavity 72, for example, from the compressor section 44 (see FIG. 2). The exhaust port 76 is in fluid communication with the rotor cavity 72. The exhaust port 76 is configured to direct combustion exhaust gas out of the rotor cavity 72. For example, the exhaust port 76 may be configured to direct the combustion exhaust gas from the rotor cavity 72 to the turbine section 46 (see FIG. 2). The fuel system passages 78 provide access to the rotor cavity 72 for a spark plug or other ignition device and/or for one or more fuel injectors of a fuel system for the engine 32.

The side housing assemblies 64 may be mounted to or otherwise disposed at (e.g., on, adjacent, or proximate) the first end 68 and the second end 70. For example, the side housing assemblies 64 may include a first side housing assembly 64A disposed at the first end 68 and a second side housing assembly 64B disposed at the second end 70. The side housing assemblies 64 further form the rotor cavity 72 (e.g., axial bounds of the rotor cavity 72). Each of the first side housing assembly 64A and the second side housing assembly 64B may include a respective shaft aperture (not shown) through which the engine shaft 52 may extend along the rotational axis 50 through the rotor cavity 72.

The rotor 60 of FIGS. 3 and 4 is coupled to an eccentric portion 80 of the engine shaft 40. The rotor 60 is disposed within the rotor cavity 72. The rotor 60 is configured to rotate (e.g., in rotation direction R) with the eccentric portion 80 about a rotational axis 82 of the rotor 60 to perform orbital revolutions within the rotor cavity 72. The rotational axis 82 may be offset from and parallel to the rotational axis 42.

In operation of the engine 32, fuel is directed into the rotor cavity 72 and igniting in a defined sequence. During each orbital revolution of the rotor 60, each of a plurality of working chambers 84 within the rotor cavity 72 varies in volume and moves about the rotor cavity 72 to undergo four phases of intake, compression, expansion, and exhaust, thereby driving rotation of the rotor 60 and the engine shaft 40.

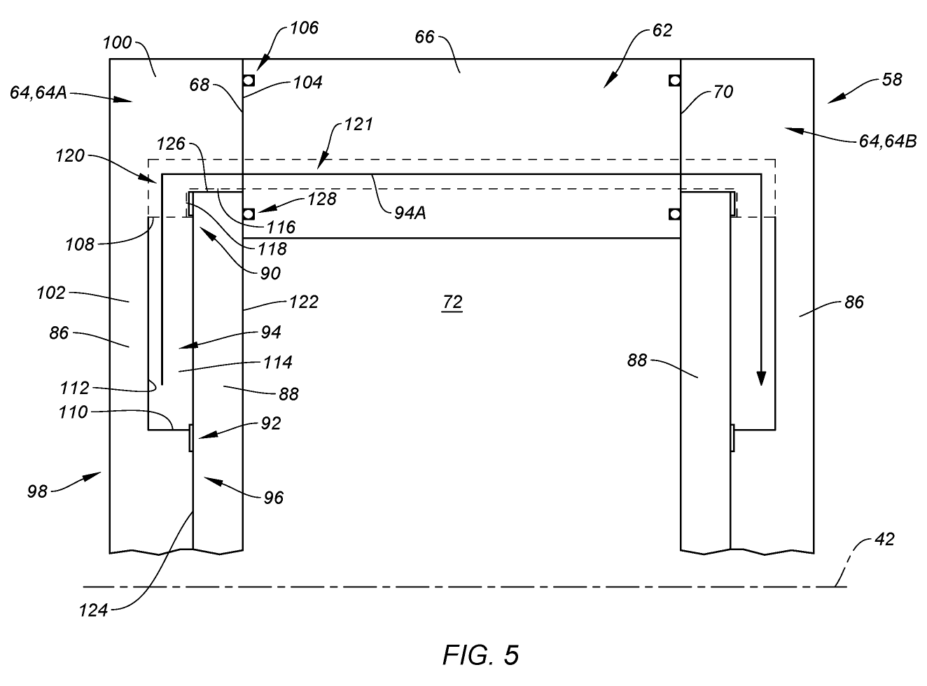

FIG. 5 schematically illustrates a cutaway, side view of a portion of the engine housing 58 including the rotor housing 62 (e.g., the rotor housing body 66) and the side housing assemblies 64, 64A-B. Each of the side housing assemblies 64 includes a side housing body 86, a side plate 88, and an outer shim assembly 90. Each of the side housing assemblies 64 may additionally include an inner shim 92. The rotor housing body 66 and the side housing assemblies 64, 64A-B form a coolant passage 94. The coolant passage 94 is configured to direct a coolant through the rotor housing 62 and the side housing assemblies 64 along a coolant flow path 94A to facilitate cooling of the rotor housing 62 and the side housing assemblies 64. The coolant channel 94 may include a coolant inlet or a coolant outlet (not shown) for directing coolant into and out of the coolant passage 94 along the coolant flow path 94A.

The side housing body 86 extends (e.g., axially extends) between and to an inner side 96 of the side housing body 86 and an outer side 98 of the side housing body 86. The side housing body 86 includes an outer radial body portion 100 and an inner radial body portion 102. The outer radial body portion 100 is disposed radially outward of the coolant passage 94. The outer radial body portion 100 forms a sealing surface 104 at (e.g., on, adjacent, or proximate) the rotor housing body 66 (e.g., the first end 68 or the second end 70). The inner radial body portion 102 extends radially inward from the outer radial body portion 100. The inner radial body portion 102 forms portions of the coolant passage 94 on the inner side 96. The engine housing 58 may include an outer fluid seal 106 (e.g., an O-ring) positioned between and contacting the outer radial body portion 100 (e.g., the sealing surface 104) and the rotor housing body 66 (e.g., the first end 68 or the second end 70). The outer fluid seal 106 extends about (e.g., completely around) the rotational axis 42 between the rotor housing body 66 and the side housing body 86. The side housing body 86 includes a side housing body material. The side housing body material may form all or a substantial portion of the side housing body 86. The side housing body material may be metal such as, but not limited to aluminum. The present disclosure, however, is not limited to the use of a particular material or combination of materials for the side housing body material.

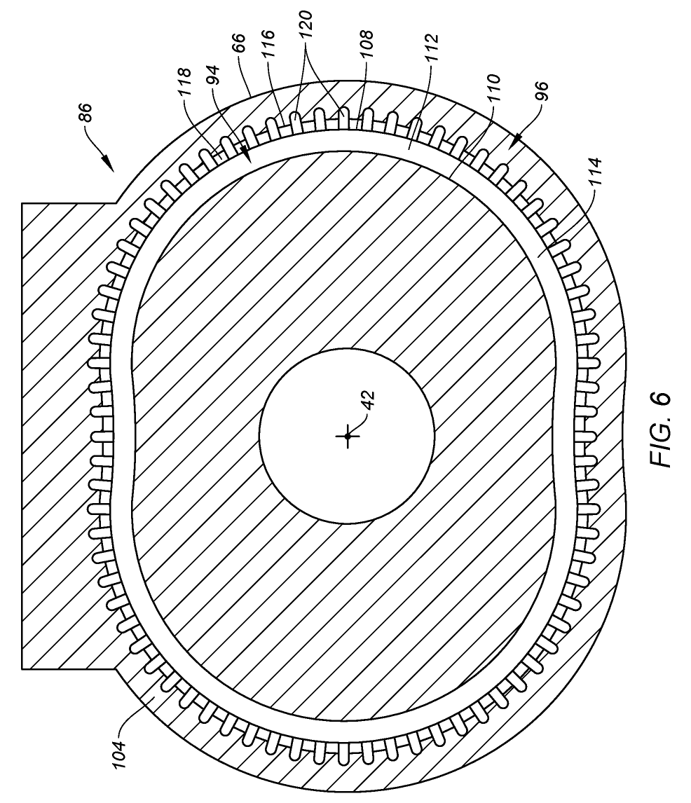

The side housing body 86 forms the coolant passage 94 on the inner side 96. FIG. 6 illustrates a view of the inner side 96 showing the coolant passage 94. The side housing body 86 (e.g., the inner radial body portion 102) includes an outer sidewall 108, an inner sidewall 110, and an endwall 112 forming a primary channel 114 of the coolant passage 94. The outer sidewall 108, the inner sidewall 110, the endwall 112, and the primary channel 114 extend about (e.g., completely around) the rotational axis 42, for example, matching the epitrochoid shape of the engine housing 58. The endwall 112 is axially recessed from the inner side 96. The outer sidewall 108 and the inner sidewall 110 extend axially from the endwall 112 to or toward the inner side 96. The side housing body 86 includes an inner wall 116 which is transverse (e.g., orthogonal) to the sealing surface 104. The side housing body 86 includes a shoulder 118 which projects outward from the inner wall 116 and provides support for the side plate 88 and the outer shim assembly 90. The inner wall 116 and the shoulder 118 are interrupted by a plurality of secondary channels 120 of the coolant passage 94 extending from the primary channel 114 to and through the sealing surface 104. The secondary channels 120 are connected in fluid communication with a respective plurality of channels 121 of the coolant passage 94 formed by the rotor housing body 66.

The side plate 88 extends (e.g., axially extends) between and to an inner side 122 of the side plate 88 and an outer side 124 of the side plate 88. The side plate 88 includes a perimeter edge 126 circumscribing the inner side 122 and the outer side 124. The side plate 88 (e.g., the perimeter edge 126) may have an epitrochoid shape similar to that of the rotor cavity 72 and the side housing body 86. The side plate 88 is disposed axially between the rotor housing body 66 and the inner radial body portion 102 of the side housing body 86. The inner side 122 faces the rotor 60 and forms a portion of the rotor cavity 72. The inner side 122 (e.g., at the perimeter edge 126) is disposed at (e.g., on, adjacent, or proximate) the side housing body 86 (e.g., the first end 68 or the second end 70). The engine housing 58 may include an inner fluid seal 128 (e.g., an O-ring) positioned between and contacting the side plate 88 (e.g., the inner side 122) and the rotor housing body 66 (e.g., the first end 68 or the second end 70). The inner fluid seal 128 extends about (e.g., completely around) the rotational axis 42 between the side plate 88 and the rotor housing body 66. The outer side 124 is disposed in contact with the outer shim assembly 90 and may additionally be disposed in contact with the inner shim 92. The outer side 124 is disposed axially adjacent but spaced from the side housing body 86 (e.g., the inner side 96) by an axial gap. The outer side 124 faces and forms a portion of the coolant passage 94 (e.g., the primary channel 114). The side plate 88 includes a side plate material. The perimeter edge 126 is disposed at (e.g., on, adjacent, or proximate) the shoulder 118. The perimeter edge 126 forms a portion of each of the secondary channels 120. The side plate material may form all or a substantial portion of the side plate 88. The side plate material may be different than the side housing body material. For example, the side plate material may be a harder material relative to the side housing body material. The side plate material may be a ceramic material such as, but not limited to, silicon carbide (SiC).

In the assembled state, the engine housing 58 components, including the rotor housing body 66 and the side housing body 86 and the side plate 88 of each of the side housing assemblies 64, 64A-B, are stacked together with a high axial compression load. In at least some conventional rotary engine housings without the present disclosure outer shim assembly 90 , a magnitude of this axial compression load may influence a size of an axial gap between the side plate and the rotor housing body. As a size of this axial gap increases (e.g., due to lower axial compression load), fluid sealing between the side plate and the rotor housing body may be adversely impacted and seals between the side plate and the rotor housing body may be exposed to high-temperature conditions which may accelerate seal failure. Conversely, as a size of this axial gap decreases (e.g., due to a higher axial compression load), forces on the side plate may begin to increase rapidly, causing wear and increased stress on the side plate axial interfaces, for example, due to thermal growth of the engine housing components. Accordingly, this axial gap must be controlled to a tight tolerance to balance the clamping force of the side plate and the temperature of the seals, which can prove to be difficult and costly.

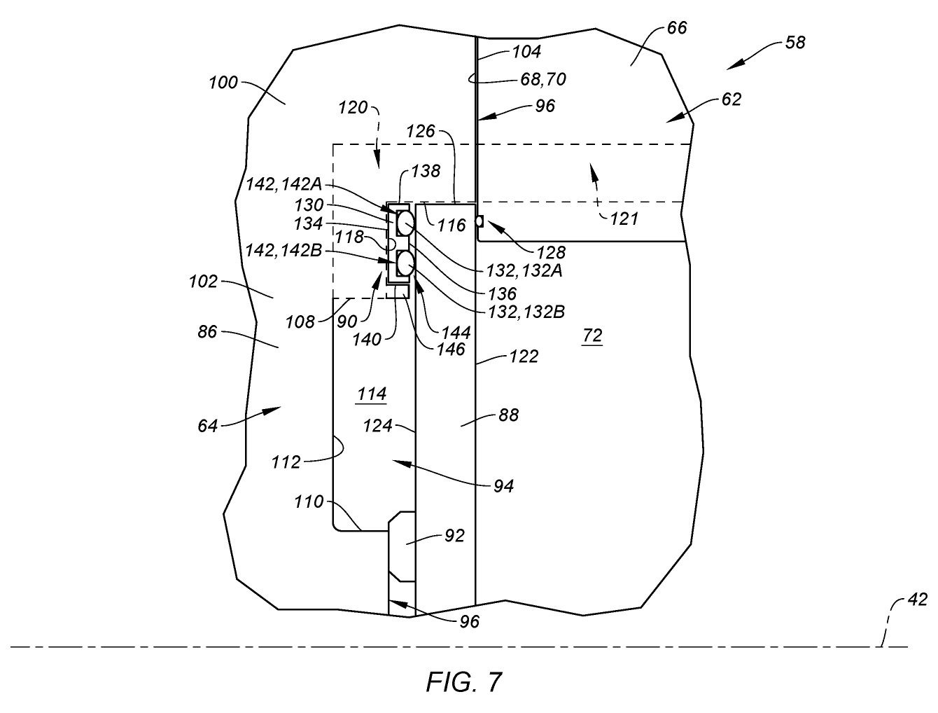

Referring to FIG. 7, the outer shim assembly 90 includes a shim body 130 and at least one compliant member 132. The shim body 130 extends (e.g., axially extends) between and to an outer axial side surface 134 of the shim body 130 and an inner axial side surface 136 of the shim body 130. The shim body 130 extends (e.g., radially extends) between and to an outer radial side surface 138 of the shim body 130 and an inner radial side surface 140 of the shim body 130. The shim body 130 extends about (e.g., completely around) the rotational axis 42, for example, matching the epitrochoid shape of the engine housing 58. The shim body 130 may be configured as a single-piece component extending about the rotational axis 42. Alternatively, the shim body 130 may be formed by a plurality of body segments assembled together and collectively extending about the rotational axis 42. The shim body 130 may form at least one seal groove 142 for the compliant member 132 on the inner axial side surface 136. The seal groove 142 extends along the inner axial side surface 136 about (e.g., completely around) the rotational axis 42. The shim body 130 of FIG. 7 includes two seal grooves 142—a first seal groove 142A and a second seal groove 142B radially separated from the first seal groove 142A. The present disclosure, however, is not limited to the foregoing exemplary configuration of the outer shim assembly 90 and its compliant members 132 and seal grooves 142 and, in some embodiments, the shim body 130 may not form or include a seal groove.

The shim body 130 includes a shim body material. The shim body material may form all or a substantial portion of the shim body 130. Examples of the shim body material include rigid (e.g., high stiffness) materials such as, but not limited to, stainless steel, cobalt-chromium alloys, and the like. In some embodiments, the shim body 130 may include a wear coating on the shim body material (e.g., forming an exterior surface of the shim body 130). Alternatively, in some embodiments, the side housing body 86 and the shim body 130 may form a unitary structure. The term “unitary structure” as used herein means a single component, wherein the side housing body 86 and the shim body 130 are an inseparable body (e.g., formed of a single material, or a weldment of independent elements, etc.).

The shim body 130 is disposed axially between and adjacent the side housing body 86 and the side plate 88 (e.g., the outer side 124). The shim body 130 is disposed at (e.g., on, adjacent, or proximate) the perimeter edge 126. The shim body 130 may be disposed radially coincident with the inner fluid seal 128 as shown, for example, in FIG. 7. The outer axial side surface 134 is disposed on the shoulder 118. Accordingly, the outer axial side surface 134 forms a portion of the secondary channels 120. The inner axial side surface 136 is axially spaced from the side plate 88 (e.g., the outer side 124) by an axial gap 144. The axial gap 144 illustrated in FIG. 7 may be understood to be proportionally exaggerated for clarity. The shim body 130 may be radially retained by the side housing body 86. For example, the shim body 130 may be positioned radially between the inner wall 116 and a rail 146 formed by the side housing body 86. The outer radial side surface 138 may be disposed at (e.g., on, adjacent, or proximate) the inner wall 116 and the inner radial side surface 140 may be disposed at (e.g., on, adjacent, or proximate) the rail 146.

The compliant member 132 is disposed axially between and contacting the shim body 130 and the side plate 88 (e.g., the outer side 124). The compliant member 132 forms the axial gap 144. The compliant member 132 extends about (e.g., completely around) the rotational axis 42, for example, matching the epitrochoid shape of the engine housing 58. The compliant member 132 may be configured as a single-piece component extending about the rotational axis 42. Alternatively, the compliant member 132 may be formed by a plurality of body segments assembled together and collectively extending about the rotational axis 42. The compliant member 132 may include a resilient body material such as an elastomeric material. Examples of the resilient body material may include, but are not limited to, rubber, plastic, and combinations thereof. For example, the compliant member 132 may be an elastomeric O-ring. Alternatively, the compliant member 132 may include metallic seals such as, but not limited to, C-seals and O-seals. As shown in FIG. 7, the compliant member 132 may be disposed within the seal groove 142 to facilitate retention and positioning of the compliant member 132. The outer shim assembly 90 of FIG. 7 includes two compliant members 132—a first compliant member 132A and a second compliant member 132B. The first compliant member 132A is disposed within the first seal groove 142A and the second compliant member 132B is disposed within the second seal groove 142B. As noted above, in some embodiments, the shim body 130 may not form or include a seal groove. In this configuration of the shim body 130, the compliant member 132 may be disposed between and contacting the inner axial side surface 136 and the side plate 88 (e.g., the outer side 124). The compliant member 132 facilitates a more constant force applied on the side plate 88 with the engine housing 58 components axially stacked and compressed together in their assembled state and allows axial gap (e.g., the axial gap 144) tolerancing to be relaxed compared to conventional engine housings. The compliant member 132 additionally facilitates retention of the side plate 88 against the rotor housing body 66 and/or the inner fluid seal 128 and maintains the axial gap 144 during cold and hot engine conditions to prevent the side plate 88 from contacting the shim body 130 and the side housing body 86. The outer shim assembly 90 reduces side plate 88 movement during operation, thereby minimizing side plate 88 vibration, coolant pressure fluctuations, and side plate 88 wear.

In some embodiments, the side housing assemblies 64 may each include the inner shim 92. The inner shim 92 is disposed axially between and adjacent the side housing body 86 and the side plate 88 (e.g., the outer side 124). The inner shim 92 is disposed radially inward of the outer shim assembly 90. For example, the inner shim 92 may be disposed at (e.g., on, adjacent, or proximate) the inner sidewall 110. The inner shim 92 is disposed on the side housing body 86 (e.g., the inner side 96). The inner shim 92 may contact the side plate 88 during at least some operating conditions of the engine 32. For example, the inner shim 92 may be axially spaced from the side plate 88 (e.g., the outer side 124) during cold engine conditions and may contact the side plate (e.g., the outer side 124) during hot engine conditions. The inner shim 92 may include an inner shim material which is wear compatible with the side plate 88 and the side housing body 86. Additionally or alternatively, the inner shim 92 may include a wear coating on the inner shim material (e.g., forming an exterior surface of the inner shim 92). The inner shim 92 may facilitate reductions in side plate 88 bending under at least some engine 32 loading conditions.

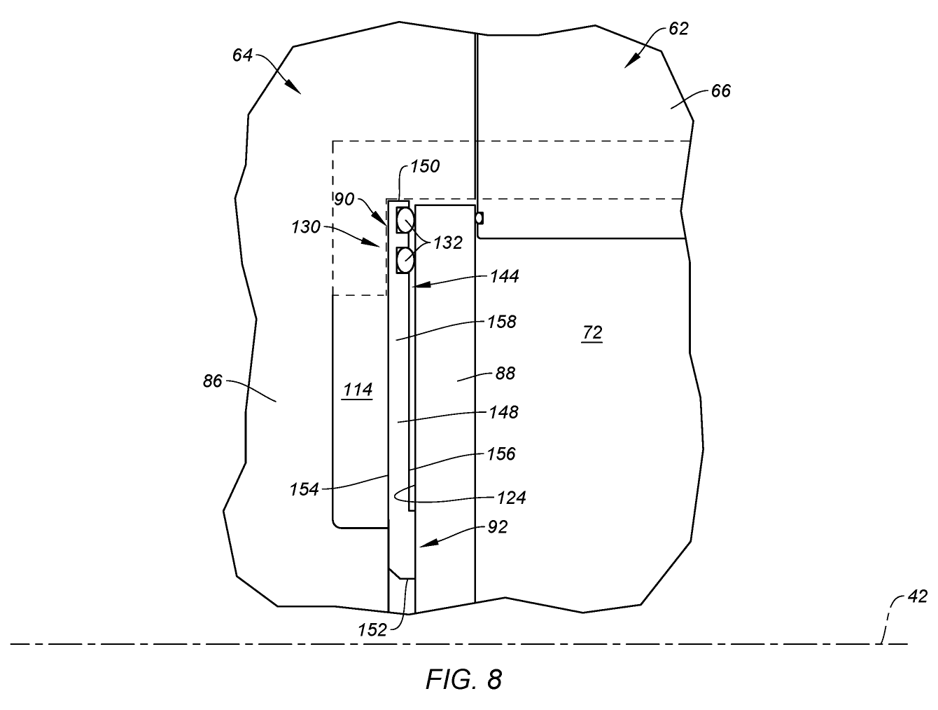

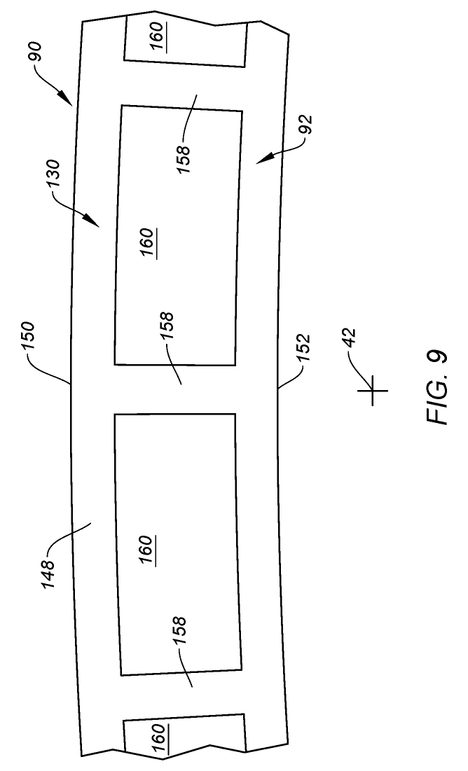

Referring to FIGS. 8 and 9, in some embodiments, the shim body 130 and the inner shim 92 may be interconnected and may collectively form portions of a shim structure 148. The shim structure 148 of FIGS. 8 and 9 extends radially between and to an outer radial end 150 of the shim structure 148 and an inner radial end 152 of the shim structure 148. The shim structure 148 extends (e.g., axially extends) between and to an outer side 154 of the shim structure 148 and an inner side 156 of the shim structure 148. The shim body 130 is disposed at (e.g., on, adjacent, or proximate) the outer radial end 150. The compliant member(s) 132 are disposed on the inner side 156 forming the axial gap 144 between the side plate 88 (e.g., the outer side 124) and the inner side 156 along at least a portion of the inner side 156 (e.g., radially outward of the inner shim 92). The inner shim 92 is disposed at (e.g., on, adjacent, or proximate) the inner radial end 150. The shim structure 148 of FIGS. 8 and 9 includes a plurality of bridge segments 158 extending between (e.g., radially between) and connecting the shim body 130 and the inner shim 92. Each of the bridge segments 158 may be spaced from (e.g., circumferentially spaced from) adjacent bridge segments 158 to form a plurality of coolant apertures 160 (or “windows”) through the shim structure 148. For example, each of the coolant apertures 160 may be formed between adjacent bridge segments 158. The coolant apertures 160 extend through the shim structure 148 from the outer side 154 to the inner side 156 to facilitate cooling of the side plate 88 (e.g., at the outer side 124) by coolant flowing through the primary channel 114. In some embodiments, the shim body 130, the inner shim 92, the bridge segments 158, and/or other portions of the shim structure 148 may form a unitary structure (e.g., a single component) wherein the shim body 130, the inner shim 92, the bridge segments 158, and/or other portions of the shim structure 148 are an inseparable body (e.g., formed of a single material, or a weldment of independent elements, etc.).

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms "a," "an," and "the" refer to one or more than one, unless the context clearly dictates otherwise. For example, the term "comprising a specimen" includes single or plural specimens and is considered equivalent to the phrase "comprising at least one specimen." The term "or" refers to a single element of stated alternative elements or a combination of two or more elements unless the context clearly indicates otherwise. As used herein, "comprises" means "includes." Thus, "comprising A or B," means "including A or B, or A and B," without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected, or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures--such as alternative materials, structures, configurations, methods, devices, and components, and so on--may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. An engine housing for a powerplant assembly, the engine housing comprising:
a rotor housing including a rotor housing body, the rotor housing body extending about an axis to form a rotor cavity of the engine housing, the rotor housing body extending between and to a first axial housing end and a second axial housing end; and
a side housing assembly including a side housing body, a side plate, and a shim assembly,
the side housing body disposed at the first axial housing end,
the side plate disposed axially between the rotor housing body and the side housing body, the side plate including an inner plate side, an outer plate side, and a perimeter edge extending from the inner plate side to the outer plate side, the inner plate side further forming the rotor cavity, and
the shim assembly including a shim body and at least one compliant member, the shim body extending between and to an outer axial side surface and an inner axial side surface, the outer axial side surface disposed on the side housing body, the inner axial side surface disposed adjacent and axially spaced from the outer plate side by an axial gap, the at least one compliant member disposed between and contacting the shim body and the outer plate side at the inner axial side surface.

2. The engine housing of claim 1, wherein the side housing body and the side plate form a coolant passage extending about the rotational axis, and the shim assembly is disposed at the coolant passage.

3. The engine housing of claim 2, wherein the side housing body forms a sealing surface, an inner wall, and a shoulder, the sealing surface contacts the rotor housing radially outward of the coolant passage, the inner wall is transverse to the sealing surface, the
shoulder projects outward from the inner wall, and the outer axial side surface is disposed on the shoulder.

4. The engine housing of claim 3, wherein the inner wall and the shoulder are interrupted by a plurality of secondary channels of the coolant passage, and the outer axial side surface forms a portion of each of the plurality of secondary channels.

5. The engine housing of claim 1, further comprising a fluid seal disposed between the inner plate side and the rotor housing body, and the shim assembly is radially coincident with the fluid seal.

6. The engine housing of claim 1, wherein the side housing assembly further includes an inner shim disposed radially inward of the shim assembly, the inner shim disposed on the side housing body, the inner shim configured to contact the side plate on the outer plate side.

7. (canceled)

8. The engine housing of claim 1, wherein the shim body includes a rigid shim material and the at least one compliant member includes an elastomeric seal material.

9. The engine housing of claim 1, wherein the shim body forms a seal groove on the inner axial side surface and the at least one compliant member is disposed within the seal groove.

10. The engine housing of claim 1, wherein the at least one compliant member includes a first compliant member and a second compliant member axially spaced from the first compliant member.

11. The engine housing of claim 1, wherein the shim assembly is disposed at the perimeter edge.

12. An engine housing for a powerplant assembly, the engine housing comprising:
a rotor housing including a rotor housing body, the rotor housing body extending about an axis to form a rotor cavity of the engine housing, the rotor housing body extending between and to a first axial housing end and a second axial housing end; and
a side housing assembly including a side housing body, a side plate, and a shim assembly,
the side housing body disposed at the first axial housing end,
the side plate including an inner plate side, an outer plate side, and a perimeter edge extending from the inner plate side to the outer plate side, the perimeter edge disposed axially between the rotor housing body and the side housing body, the inner plate side further forming the rotor cavity, and
the shim assembly disposed at the perimeter edge, the shim assembly including a shim body and at least one compliant member, the shim body disposed on the side housing body and axially spaced from the outer plate side by an axial gap, the at least one compliant member disposed between the shim body and the outer plate side forming the axial gap.

13. The engine housing of claim 12, wherein the shim body and the at least one compliant member extend about the axis between the side housing body and the side plate.

14. The engine housing of claim 12, wherein the side housing body and the side plate form a coolant passage extending about the rotational axis, and the shim assembly is disposed at the coolant passage.

15. The engine housing of claim 14, wherein the side housing body forms a sealing surface, an inner wall, and a shoulder, the sealing surface contacts the rotor housing radially outward of the coolant passage, the inner wall is transverse to the sealing surface, the
shoulder projects outward from the inner wall, and the shim body is disposed on the shoulder.

16. The engine housing of claim 15, wherein the inner wall and the shoulder are interrupted by a plurality of secondary channels of the coolant passage, and the shim body forms a portion of each of the plurality of secondary channels.

17. A powerplant assembly comprising:
a driven rotor;
an engine shaft operably coupled with the driven rotor, the engine shaft rotatable about a rotational axis;
a rotor assembly including a first rotor coupled with the engine shaft;
a rotor housing forming a rotor cavity for the first rotor, the rotor housing including a rotor housing body, the rotor housing body extending about the rotational axis, the rotor housing body extending between and to a first axial housing end and a second axial housing end; and
a side housing assembly including a side housing body, a side plate, and a shim assembly,
the side housing body disposed at the first axial housing end,
the side plate disposed axially between the rotor housing body and the side housing body, the side plate including an inner plate side, an outer plate side, and a perimeter edge extending from the inner plate side to the outer plate side, the inner plate side further forming the rotor cavity, and
the shim assembly including a shim body and at least one compliant member,
the shim body extending between and to an outer axial side surface and an inner axial side surface, the shim body extending between and to an outer radial side surface and an inner radial side surface, the outer axial side surface, the outer radial side surface, and the inner radial side surface disposed on the side housing body, the inner axial side surface disposed adjacent and axially spaced from the outer plate side by an axial gap, the at least one compliant member disposed between and contacting the shim body and the outer plate side at the inner axial side surface.

18. The powerplant assembly of claim 7, wherein the shim body forms a seal groove on the inner axial side surface and the at least one compliant member is disposed within the seal groove.

19. The powerplant assembly of claim 17, wherein the at least one compliant member includes a first compliant member and a second compliant member axially spaced from the first compliant member.

20. The powerplant assembly of claim 17, wherein the at least one compliant member includes a compliant metallic seal.
